(19) United States
(12) Patent Application Publication
(10) Pub. No.: US 2025/0098724 A1
(43) Pub. Date: Mar. 27, 2025

(54) CONTINUOUS CYCLE MACHINE AND METHOD FOR PROCESSING PEARS

(71) Applicant: Vincenzo DI PRISCO, Scafati (IT)

(72) Inventors: Vincenzo DI PRISCO, Scafati (IT); Leandro MARZAIUOLO, Scafati (IT)

(21) Appl. No.: 18/730,808

(22) PCT Filed: Jan. 26, 2023
(86) PCT No.: PCT/EP2023/025037

§ 371 Date: Jul. 22, 2024

(30) Foreign Application Priority Data
Jan. 27, 2022 (IT) 102022000001358
Jan. 27, 2022 (IT) 202022000000311
Jan. 27, 2022 (IT) 202022000000314
Jan. 27, 2022 (IT) 202022000000317

(51) Int. Cl. A23N 7/08; A23L 19/00; A23N 7/02; A23N 7/10; B65G 47/90

(52) U.S. Cl. CPC A23N 7/08; A23L 19/05; A23N 7/026; A23N 7/10; B65G 47/905; B65G 2201/0211; B65G 2203/042

(57) ABSTRACT

The object of the present invention is a machine and the continuous cycle processing process for pears, which includes mechanisms for feeding and distributing, housing and holding, aligning and expelling, enucleating the endocarp and peeling the pears, whether they are of variable shape or length and in which said mechanisms are synchronized and form a single or more aligned and integrated processing stations

In each work station, the distribution of the pears in the fruit bowls takes place automatically and vertically; the measurement of the endocarp of the pear starting from the measurement of its calyx end, takes place through the alignment mechanism of the pears, which does not cause unnecessary compressions on the fruit, and the pulp is stressed as little as possible, maintaining its necessary consistency, and making so that the part to be enucleated, where the seeds really are, always finds itself in correspondence with the small knives in charge of carrying out this function and part of the edible fruit is not eliminated.

Furthermore, the peeling takes place using a tool which, positioning itself at the measured point, tilts following the profile of the pear closely.

Object of the present invention is a method and a machine having one or more synchronized processing stations, which performs, in each workstation, the feeding and loading on the lodging carriage, the alignment of the fruit and its expulsion, after execution of the processes that can be performed (removal of the core and seeds, and peeling), by the devices of the machine on the pears.

### STATE OF THE ART

It is known that the pear is considered a rather difficult fruit to work automatically, both for the variable dimensions in length and for its pulp, whose consistency is equally variable: in some varieties it is crunchy, in others it is very soft and grainy. To overcome these variations, the batches of pears are divided into groups, having dimensions between a minimum and a maximum value (calibration), but the batch to be processed always includes a percentage of fruit which: due to incorrect orientation, the irregularity of the shape, due to the different degree of maturation, due to other unpredictability, are ruined during processing and therefore irreparably discarded, or obtaining, at the end of processing, a percentage of edible product which depends on the percentage of product rendered unusable.

It is known that, generally, pears have a central axis of symmetry passing through the peduncle end and the calyx end. They have an endocarp or cell of seed, located at a constant distance from the calycine end.

The purpose of the prior art is to determine, mechanically or also by means of optical or laser equipment, the measurement of the position of the endocarp of a pear for the purposes of the subsequent core processing starting from its calyx end. This establishes the cutting depth and the pear will be cored and peeled, with minimum waste of edible pulp. Therefore, in the automatic processing of pears, the intervention is above all on the function of holding in position and alignment which becomes a necessary condition for obtaining a well-processed product and therefore optimized in yield and quality.

The systems adopted so far are either complex or do not appear fully effective, and during the alignment operation, the longer fruits will be pushed deeper on the punch, causing, in most cases, an undesired compression of the fruit, and the small knives will find themselves further and further away from the part where the seeds are and, consequently, there will be less and less correct enucleation of the fruit, often risking removing a part of the pulp from the fruit and/or even leaving some or all of its seeds in it.

An example of the prior art is provided by U.S. Pat. No. 2,901,014 of 1959 in the name of B.C. Coons et al. Also in this patent a cam shaft and levers control a spindle on which a pear is skewered and mechanical means are provided for measuring the pear, essentially by means of templates, and for disconnecting it from the drive shaft so that the advancement of the pear stops, when the seed zone of the pear is in line with the denucleation fins. Naturally the mechanisms adopted, exclusively of the mechanical type, do not allow a precise enucleation for all the pear sizes, furthermore the measurement mechanisms of the calyx end are located in the pear processing area, therefore subject to the accumulation of the peel and acid of the processed pears, with all the problems that can derive from it, in particular wear of the machine and obstruction and low processing speed.

It is also known to the Applicant that the fruit distribution systems in the housing cups, for machines that process pears, can be critical. It is sometimes found that the distribution of pears in the cups causes a lack of housing pears in the right position, or causes damage, especially when it comes to ripe pears; or, when a simultaneous loading of several fruits is envisaged, the mechanism appears complex and integration into the machine is poor, the speed and precision of feeding the pears are low.

It is further known that a significant percentage of waste derives from an irregular and uneven peeling of the fruit. In the case of pears, the cause of the problem is essentially the incorrect orientation of the pear to be peeled, the irregularity of the shape and the different degree of ripeness, which affect the difference in the load of the copier wheel against the pear, when it go by from area of the calyx pear to the petiole area of the pear. Pressure difference which, if significant, produces processing waste, especially when processing ripe and delicate pears.

### PURPOSES AND ADVANTAGES OF THE INVENTION

The object of the present invention is to overcome the problems of the known art by realizing a method and machine for coring and peeling fruit, essentially pears, having a synchronized mechanism comprising a fruit-carrying carriage which advances and tilts to make the pear skewer axially, from the calyx end to the peduncular end, by a tool which, by rotating, performs the nucleation, at a predefined distance starting from the calyx end of the pear, and determined by its encounter with a pad, which acts as a ruler for positioning the fruit; by a limit switch and retraction sensor of the fruit housing cup, adjustable manually or by means of an electronic position transducer managed by a PLC.

Another object of the present invention, in accordance with the previous objects, in which the synchronized mechanism of the machine, which allows the loading, feeding, lodging of the fruit and its translation and the consequent alignment and expulsion, forms a station or workstation where it is possible to carry out the processing of nucleation and peeling of the fruit, especially pears.

Another object of the present invention, in accordance with the previous objects, is a method and a modular peeling machine with several stations or workstations in line, each workstation being structurally and operationally coincident, and such that it is possible to carry out the required processing on a number of fruits at the same time, which in a preferred embodiment are six fruits, but may also be fewer or greater than six.

Another object of the present invention in accordance with the previous one is a method and a machine for coring and peeling pears, whether they are of variable shape or length, capable of aligning them during processing, so that the part to be cored, where there really are seeds, always find themselves in correspondence with the small knives assigned to carry out this function, and part of the edible fruit must not be eliminated; and furthermore, the pears are kept in position, without causing useless compressions on the pears, such that the pulp is stressed as little as possible, maintaining its necessary consistency.

Another object of the present invention is to create a device to be integrated in a machine which performs the peeling and removal of the endocarp of pears and similar fruits, capable of automatically and efficiently distributing the pears or morphologically similar fruits, in the underlying lodging cups, comprising a support frame, the collection tank, a horizontally moving feed rack and a vertically moving gripping and distributing rack for the pears to be processed.

Another object of the present invention, in accordance with the previous ones, is to create a device to be integrated in a machine which performs the peeling and removal of the endocarp of pears and similar fruits, and suitable for housing and retaining the pear or a morphologically similar, so as to guarantee the amplitude of the space necessary for the evacuation of the pear waste, and to move the housing cup axially in both directions, so as to feed and position the pear to be processed, for the machine alignment system.

Another object of the present invention in accordance with the previous object is to create a device to be integrated in a machine which carries out the peeling and removal of the endocarp of pears and similar fruits, provided, on the top of the housing cup, with a mechanism for jaw closure which guarantees an axial pre-alignment of the pears as well as their retention in position; and in which the housing cup is interchangeable with others of different sizes, to house pears of different sizes and lengths

A further object of the present invention is a method and a machine to guarantee a regular and uniform peeling even of ripe and delicate pears, without damaging them, by realizing a precision positioning device, on the pears to be peeled, which impresses the peeler cutter with a path adhering to the profile of a pear, starting from the calyx end to the peduncle end, and does not assume pressure values such as to make it partially penetrate the pear, when this has a certain degree of ripeness or in any case does not have a sufficient and/or uniform consistency.

### DESCRIPTION AND METHOD OF IMPLEMENTING THE INVENTION

Further characteristics and advantages of the invention will become clearer from the description of preferred but not exclusive embodiments of the method and of the machine, illustrated by way of example but not in limitation, in the attached drawings in which:

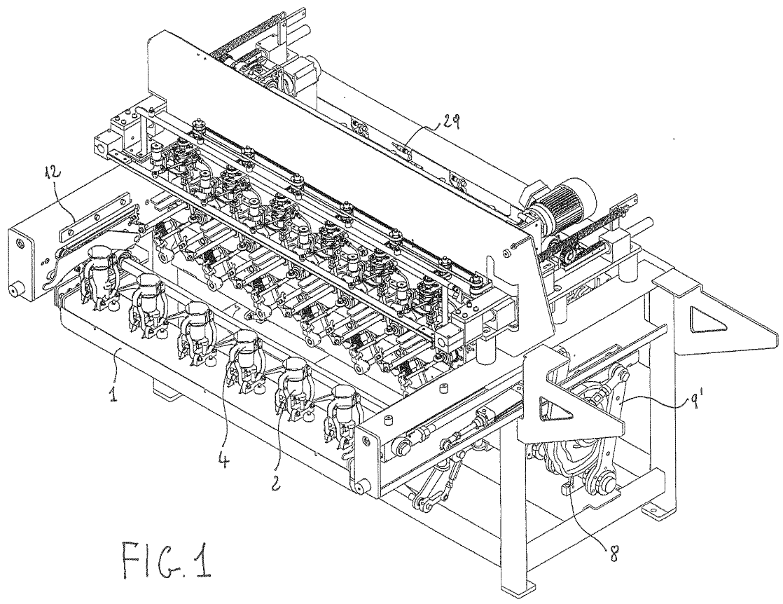

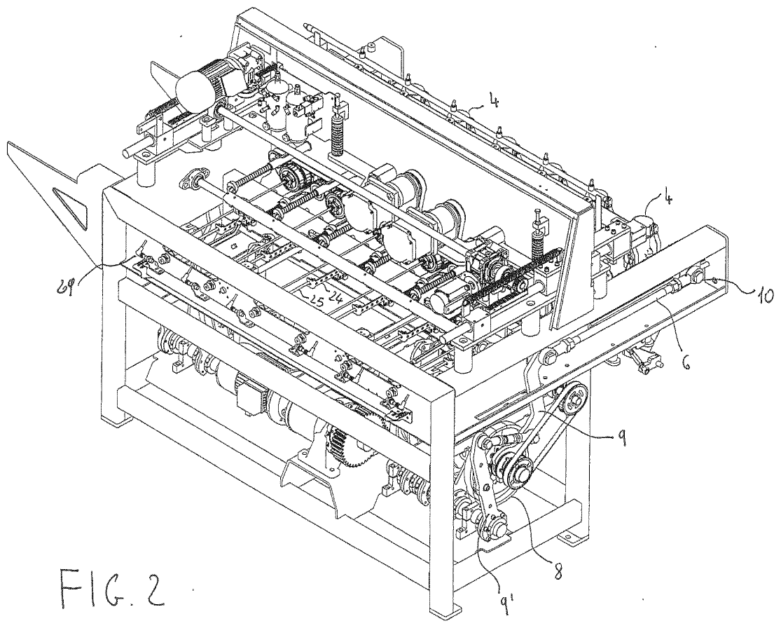

FIGS. 1 and 2, show in perspective view, front and rear respectively, a partial view of the machine with the assembly of the accommodation and alignment and ejection mechanisms for fruits to be cored and peeled;

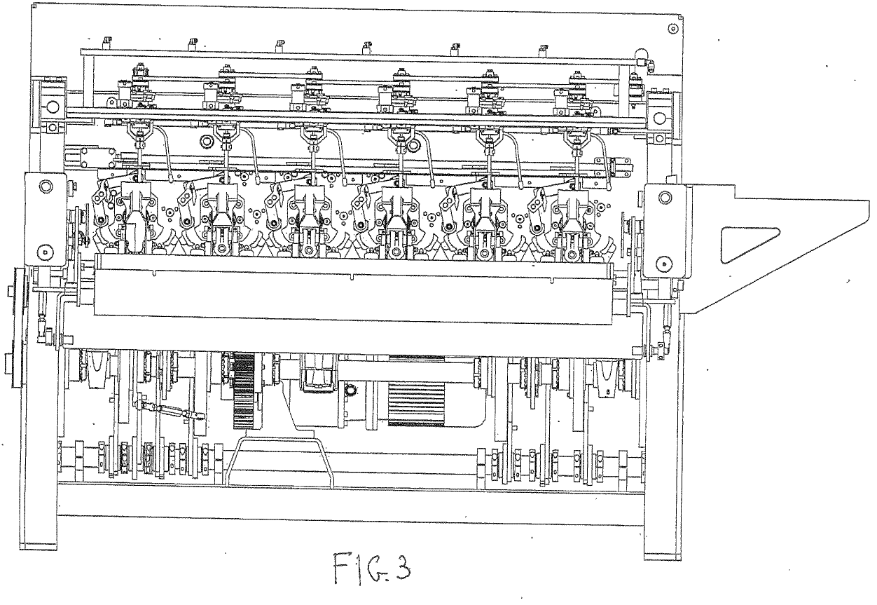

the FIG. 3 shows, in a partial front view, the pear peeling machine having six processing stations.

FIG. 4 shows a rear plan view of a detail of the machine, essentially the sensor holder bar and the graduated brackets for manual adjustment of the position of the fruit to be aligned;

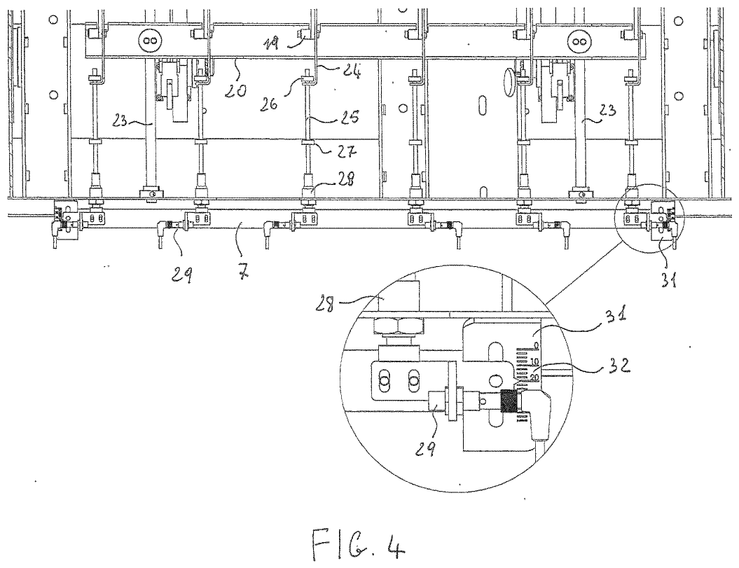

the FIG. 5 shows, in an alternative embodiment of the present invention, respectively, a rear plan view of a detail of the machine, essentially the position transducer for registering, via PLC, the position of the fruit to be aligned;

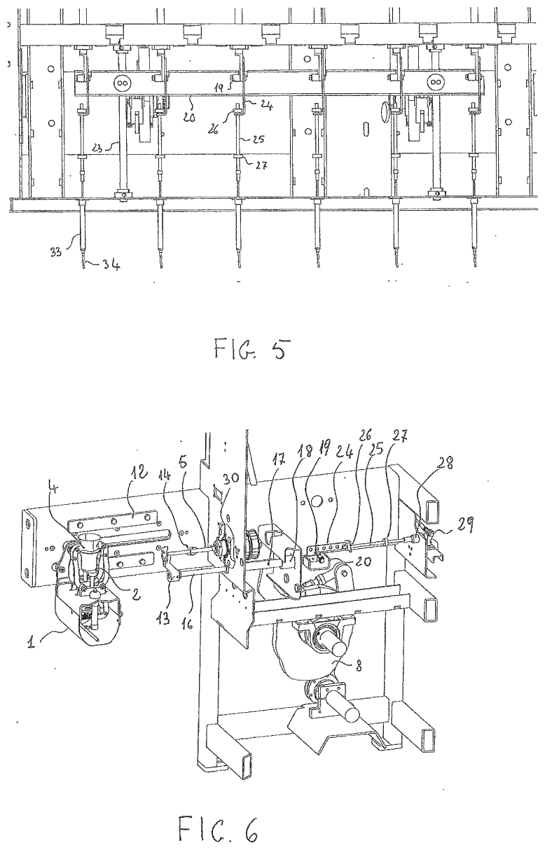

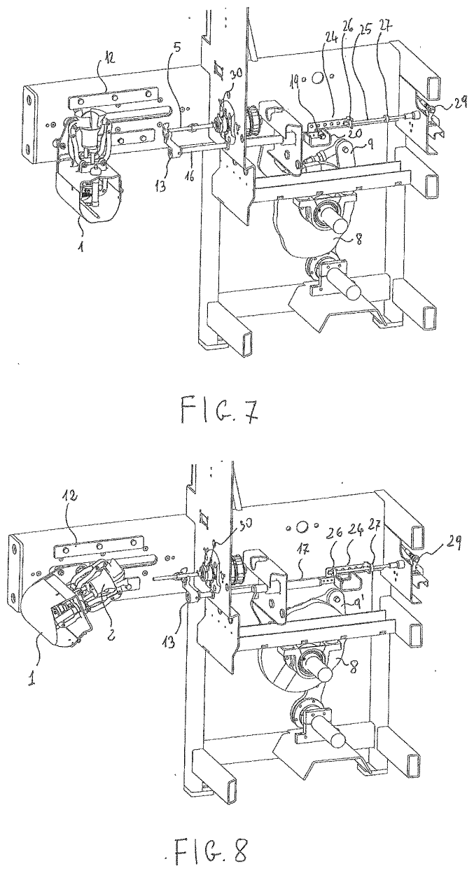

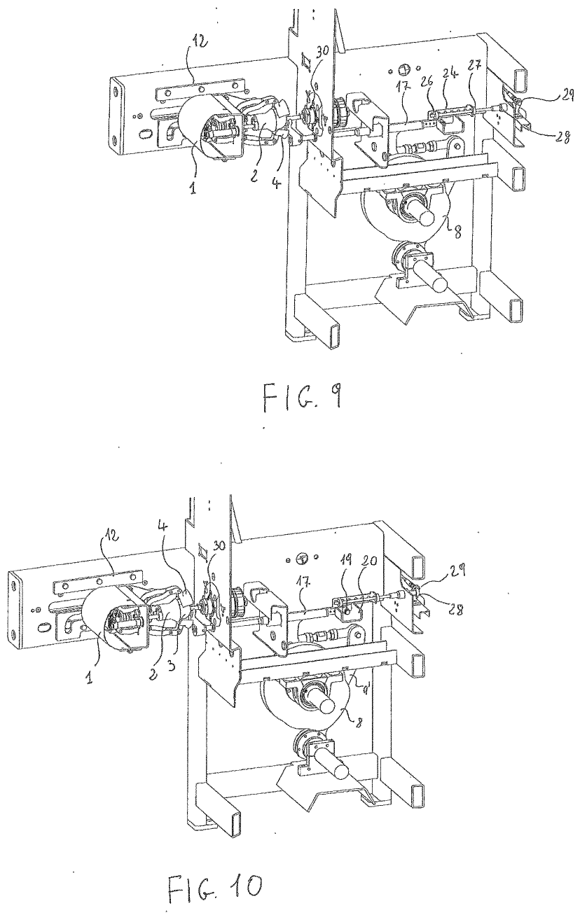

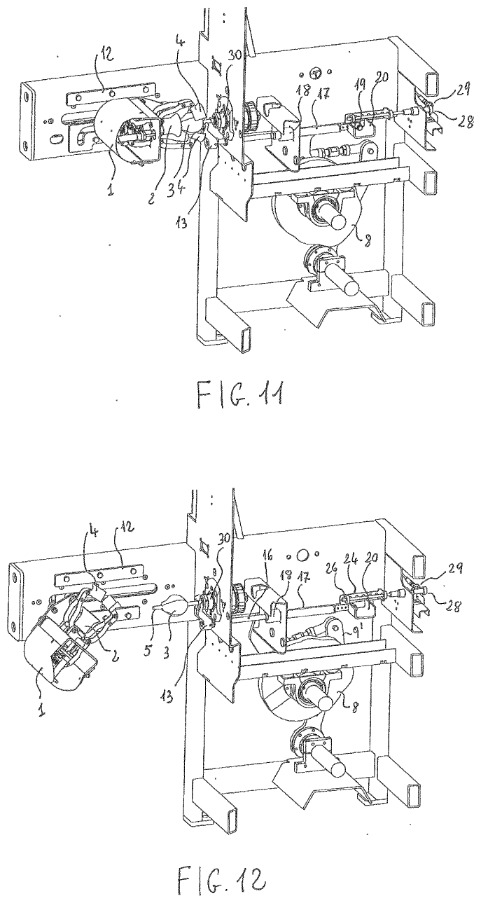

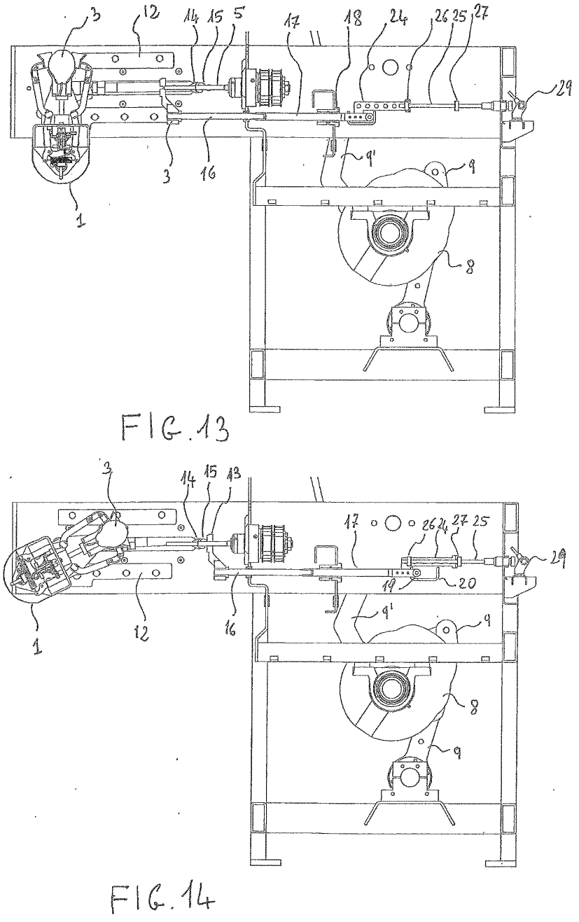

FIGS. 6 to 12 show, in a perspective view, the assembly of the mechanisms for loading and housing, aligning and ejecting fruits to be cored and peeled, and the phases of loading into the cup for housing, aligning and processing the fruit;

FIG. from 13 to 18, show in a lateral plan view, the fruit in the various phases, respectively of housing in the cup, rotation from the vertical position to the horizontal position, insertion into the punch, alignment, processing and ejection of the fruit;

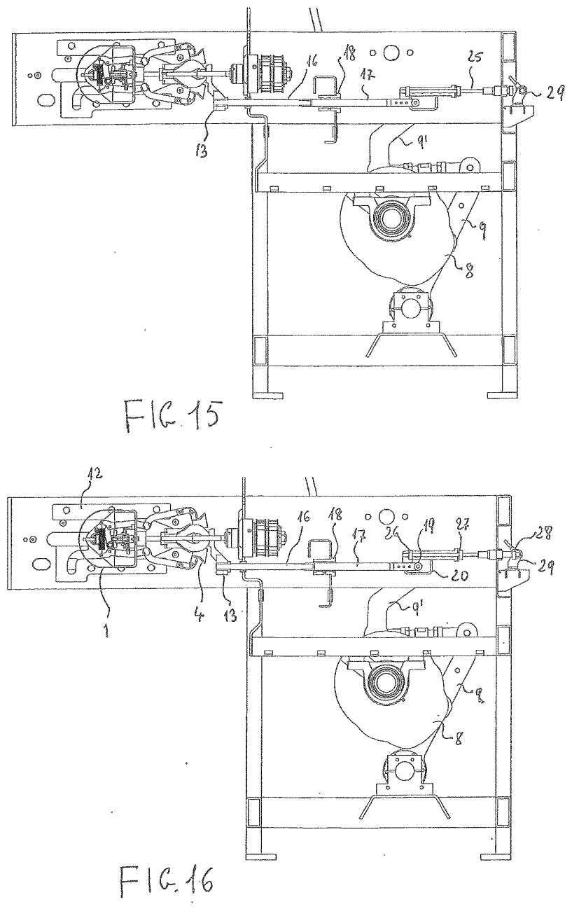

the FIG. 19, illustrates, in a three-dimensional view and in a simplified manner, a position for housing the fruit opposite the punch tool and the movement mechanism;

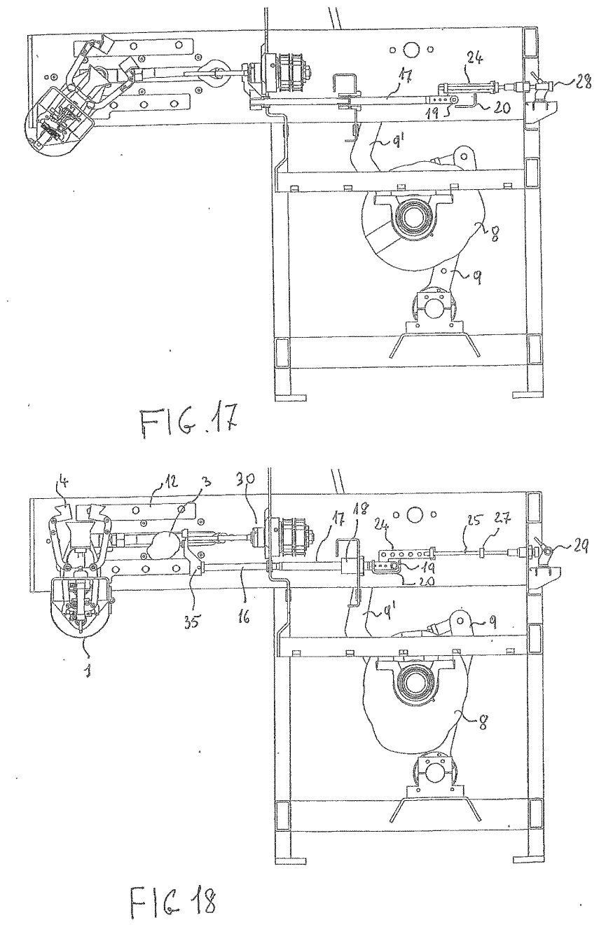

FIG. 20 shows, in a side plan view, the movement mechanism of the trolley with the pear lodging station;

the FIG. 21, illustrates, in a three-dimensional rear view and in a simplified way, the movement mechanism of the trolley and of a position for housing the fruit as well as some of the elements which contribute to realizing the alignment of the pear on the punch tool;

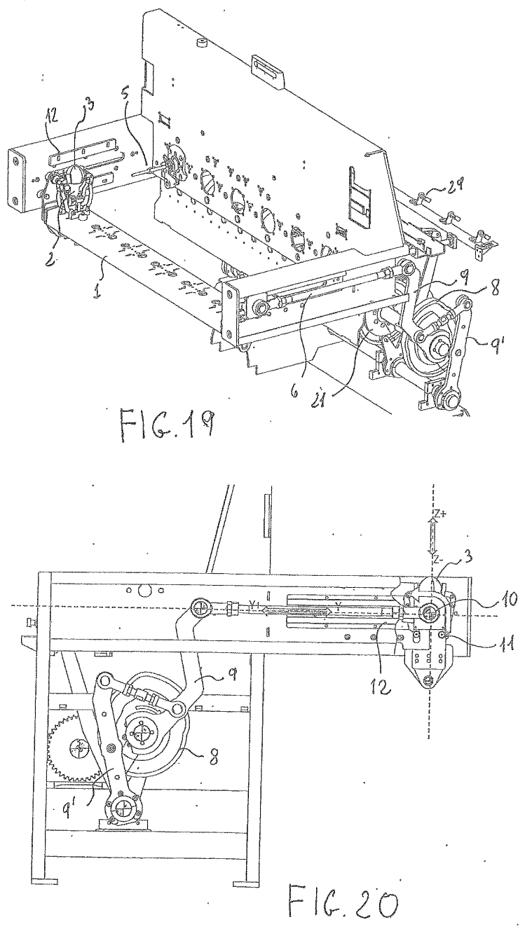

the FIG. 22, shows, in a three-dimensional view and in a simplified way, a detail of the elements which contribute to realizing the alignment of the pear on the punch tool.

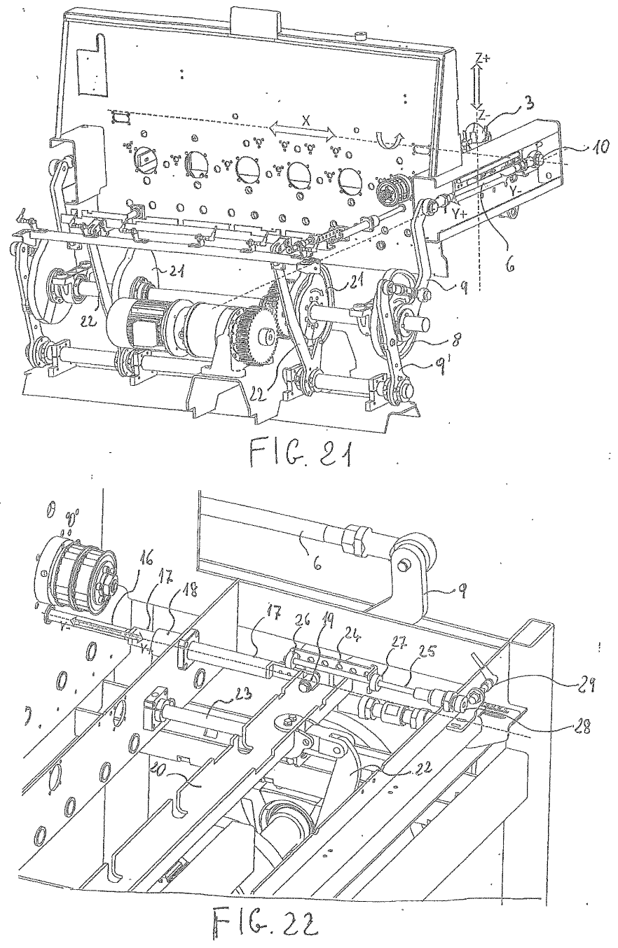

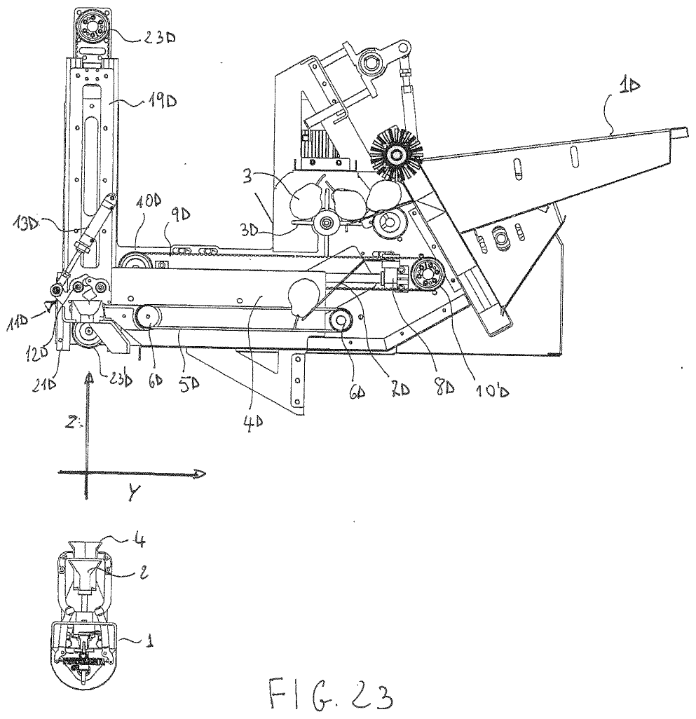

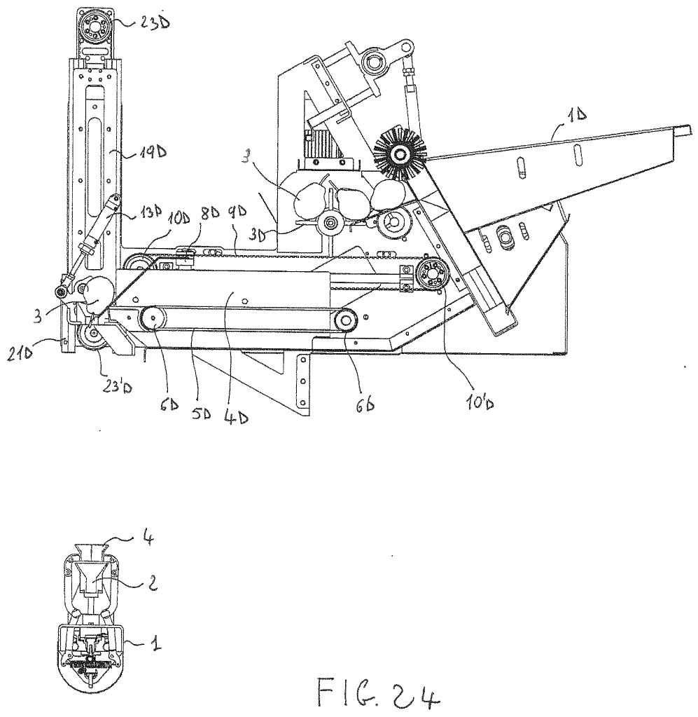

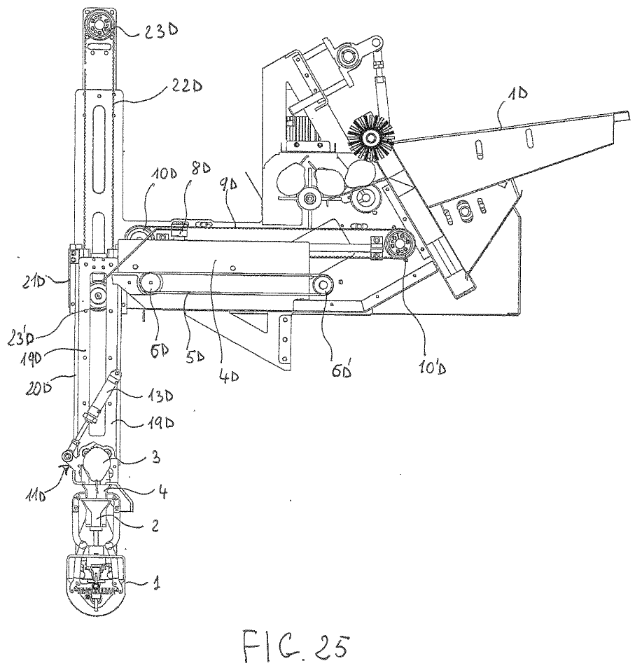

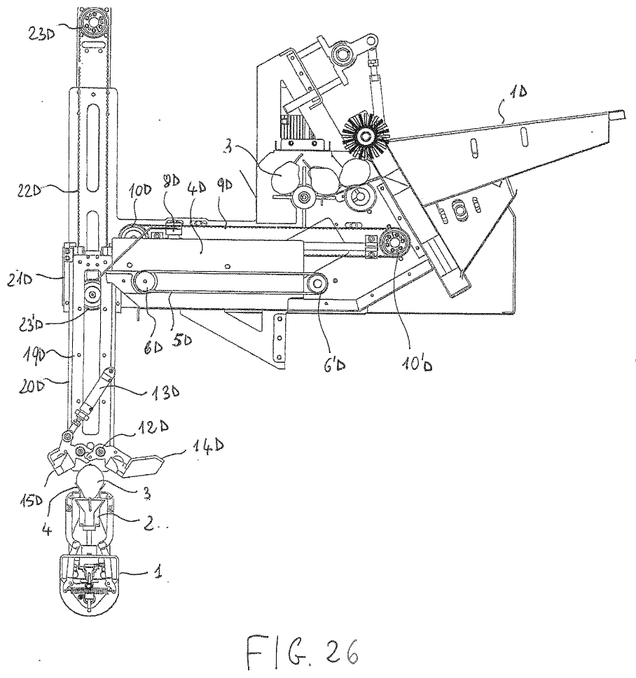

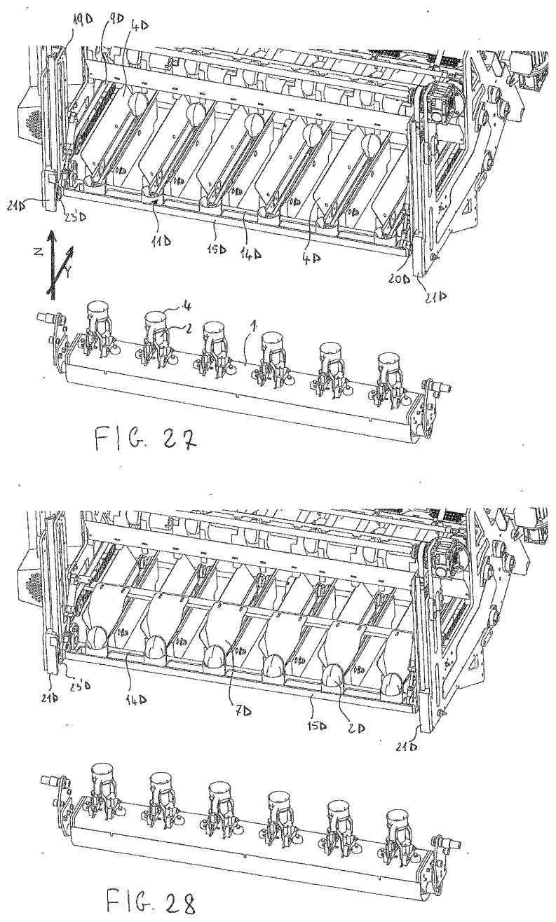

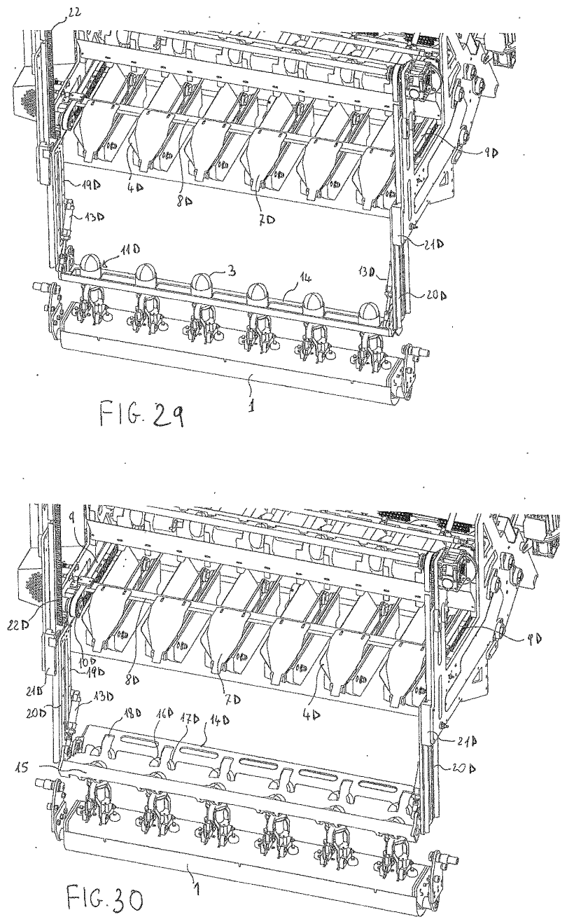

the FIGS. 23, 24, 25 and 26 show, in a side plan view, the assembly of the distribution device in the various operating positions, with the trolley and the housing cup in the underlying position;

FIG. 27, 28, 29, 30 show, in a perspective view, the assembly of the feed and distribution device, in the various operating positions, with the carriage and the housing cup in the underlying position;

FIG. 31 shows a detail of the device in a lateral plan view with the gripping mechanism open, after having deposited the pear in the underlying housing cup of the loading trolley;

FIG. 32 shows a detail of the device in a side plan view with the gripping mechanism closed, after having deposited the pear in the underlying housing cup of the loading carriage.

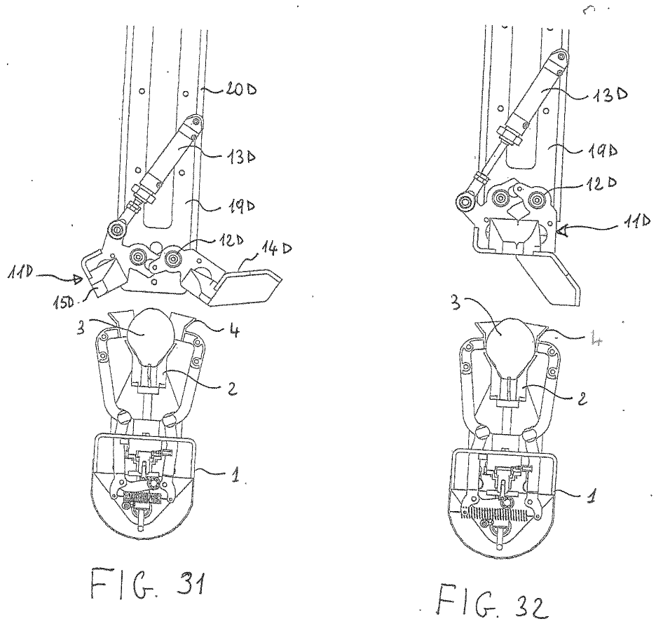

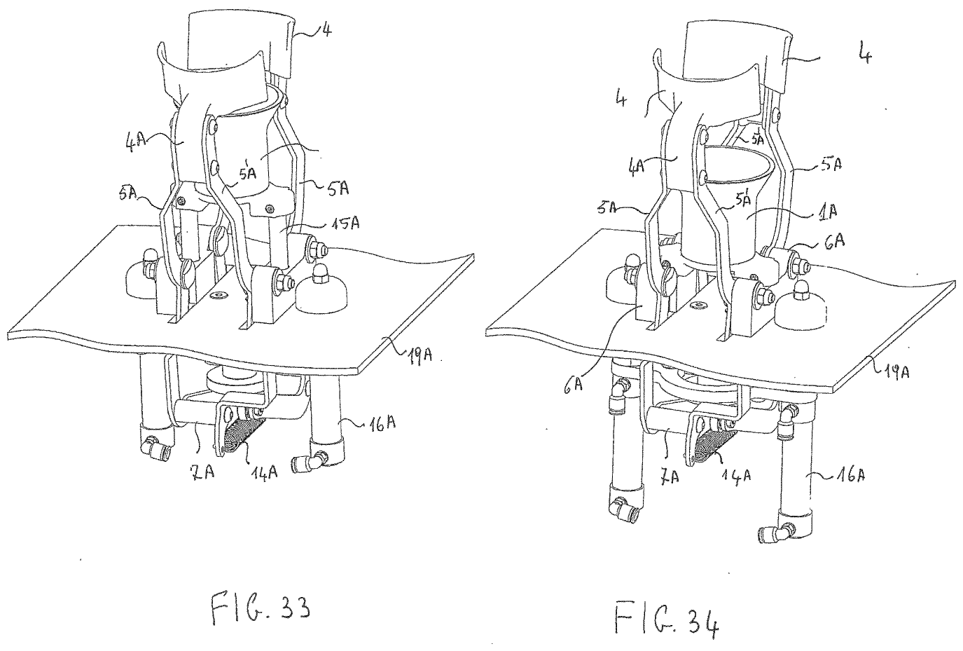

FIG. 33 shows a perspective view of the assembly of the housing and holding device, when the housing cup is positioned axially upwards, and the jaws are open;

the FIG. 34, shows in a perspective view the assembly of the housing and holding device, when the housing cup is positioned axially downwards, and the jaws are open;

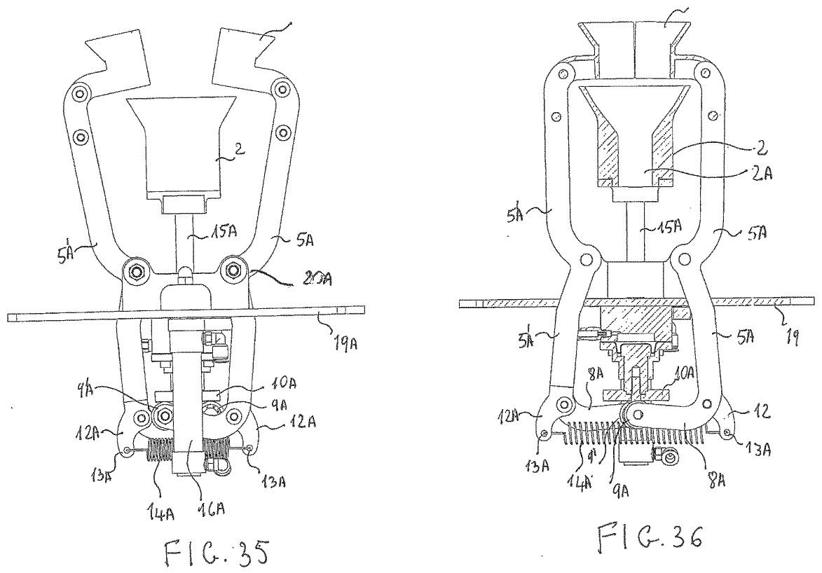

FIG. 35 shows a lateral plan view of the housing and holding device with the opening and holding jaws open and the housing cup in the high position;

FIG. 36 shows a plan view, in lateral section, of the housing and holding device with the invitation and holding jaws closed and the housing cup in the high position;

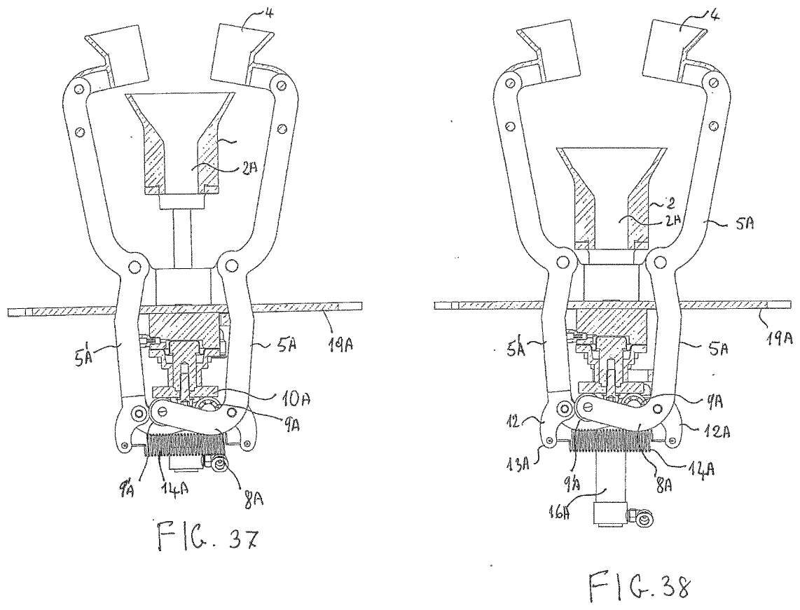

FIG. 37 shows a plan view, in lateral section, of the housing and holding device with the opening and holding jaws open and the housing cup in the high position;

the FIG. 38 shows a plan view, in lateral section, of the housing and holding device with the opening and holding jaws open and the housing cup in the low position;

FIG. 39, shows the housing and holding device in a bottom plan view;

FIG. 40 shows an exploded view of the housing and holding device with all its components, in one embodiment;

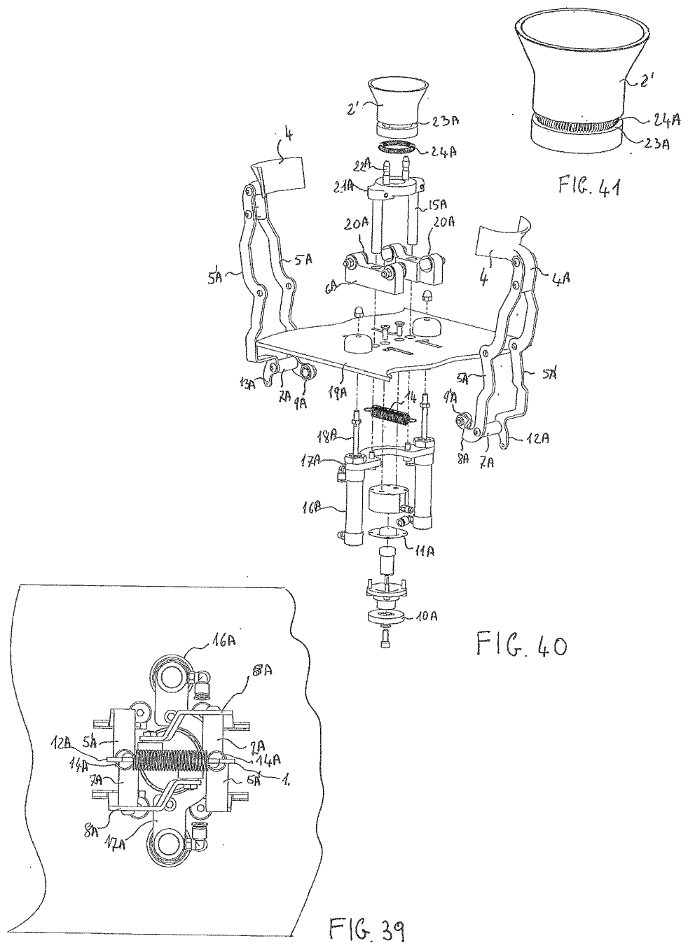

FIG. 41 shows the enlarged detail of the accommodation cup in one embodiment.

FIG. 42 shows the peeler assembly in a perspective view.

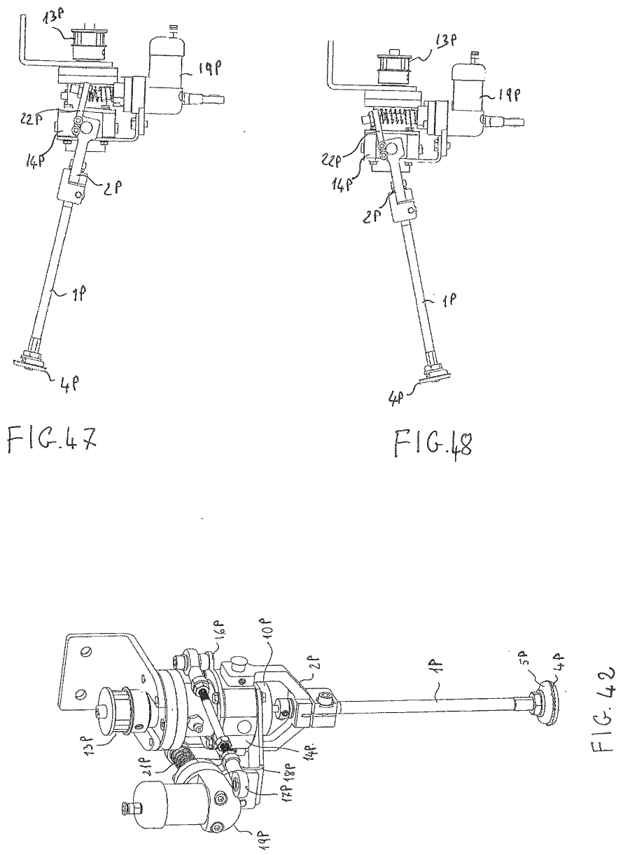

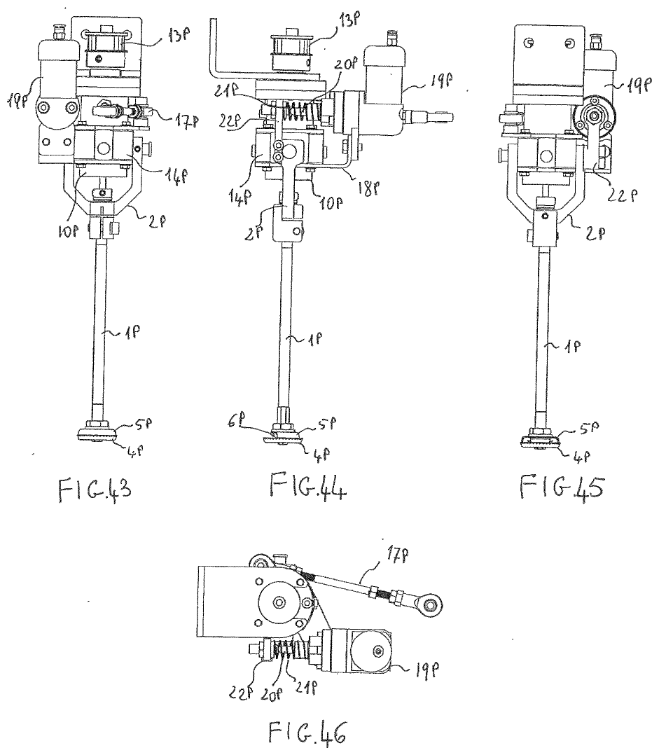

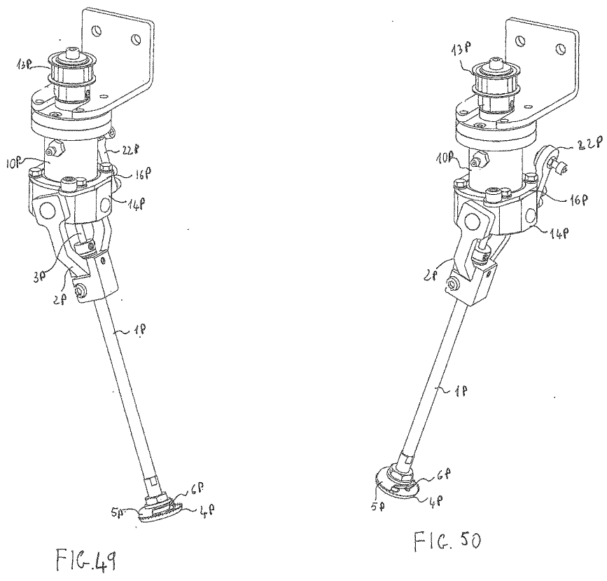

FIGS. 43, 44, 45, and 46, show the peeling device assembly in plan view, respectively in a front, side, rear and top view;

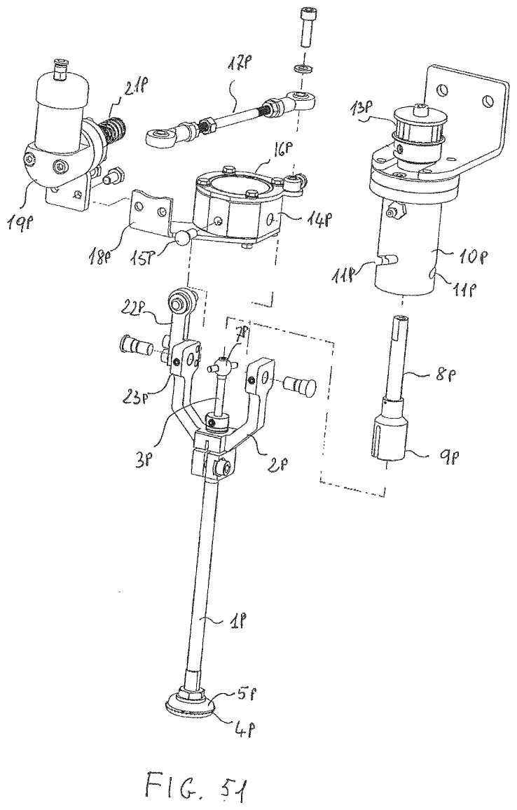

FIGS. 47 and 48 schematically show in a plan view, the possibility of tilting the peeling stem of the tool;

FIGS. 49 and 50 show, in a three-dimensional view, the peeling device, without the shock absorber/damper device, and with the rod FIGS. 49 and 50 show, in a three-dimensional view, the peeling device, without the shock absorber/damper device, and with the peeling stem inclined;

FIG. 51 shows in an exploded view all the components of the peeling device:

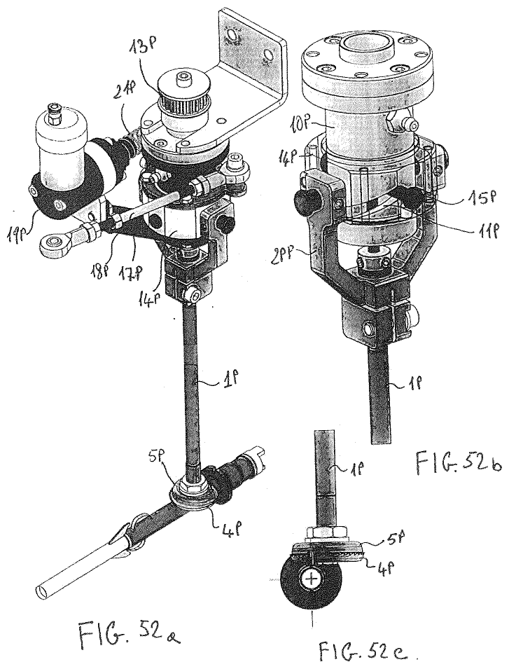

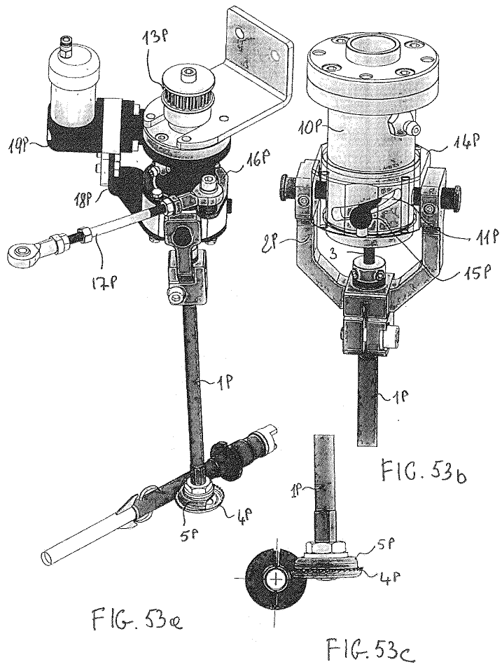

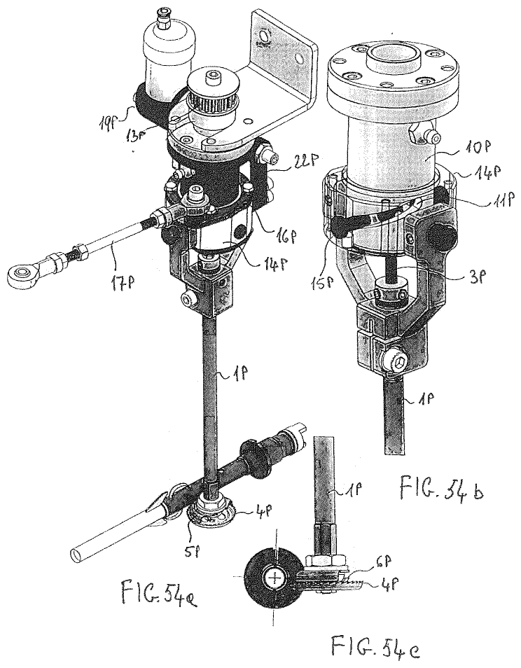

FIG. 52a, 52b, 52c, 53a, 53b, 53c, 54a, 54b 54c. show in perspective, the various positions that the circular cutter assumes with respect to the punch tool for alignment and pear enucleation.

In the context of the description and in the figures, reference is made to the orthogonal axes X, Y and Z relative to the indication of a direction in space of the movement of the machine components and they refer to an indication of direction along the axis of longitudinal symmetry of the ‘element of the device to which it refers; in particular the words: low, high, vertical, inferiorly, are relative to an indication of direction along a vertical reference axis Z; the words: forward, backward, minimum, maximum, horizontally, are relative to an indication of direction, along a horizontal reference axis Y.

In accordance with the attached drawings, the machine for processing pears to be cored and peeled includes the support frame and the various mechanisms for moving the fruit to be processed.

The distribution device includes the support frame, the collection tank, a horizontally moving feeding rack and a vertically moving gripping and distributing rack of the pears to be processed.

More specifically, the pear handling assembly comprises the collection tank (1D), from where the pears (3) are directed onto the horizontally moving feed rack, made up of six rotating selectors (3D), and from which they fall on the underlying corresponding six V-shaped channels (4D), with facing flared sides and converging towards the open bottom, within which the fruit is dragged and oriented with the petiole downwards, by means of a pair of toothed belts (5D) moved by the driving pulleys (6D) whose rotation occurs only in one direction, with which each raceway is provided. Each individual pear moves along its own channel (4D), where it was deposited, in competition with an inclined thrust plate (7D). The carriage (8D), to which each of the six thrust plates are fixed, is moved horizontally, in both directions, forward and backward, by the toothed belts (9D) and pulleys with bidirectional movement (10D) placed on the two sides of the intake rack with horizontal movement.

At the end of the stroke, each thrust plate (7D) deposits the pear with the peduncle facing downwards, into the specially shaped gripping mechanism (11D) of the gripping and dispensing rack.

Each gripping mechanism (11D) is shaped in two halves, connected by rotation pins (12D) and its opening and closing is controlled by a pneumatic actuator (13D).

Each half of the gripping mechanism (11D) consists of a differently shaped metal plate (14D) and (15D), which has a semi-support base and a vertical containment wall, shaped like a semicircle, at its bottom. The shaped plate (14D), in correspondence with the entry direction of the pear, is shaped so as not to interfere with the pear, keeping it in a vertical position; in fact, its vertical wall is divided into two (16D), (17D) and the base has a slot (18D), within which the peduncle slides, when the inclined plate (7D) of the carriage (8D) pushes the pear to lodge in the gripping mechanism (11D).

The fruit gripping and distributing rack consists of a downward vertical transfer mechanism for distributing the fruit, consisting of a rectangular plate with slots (19D) along its longitudinal centreline, and provided on the longitudinal sides with rails (20D), which allow it to slide on a pair of linear guides made up of L-section bars (21D), which guide the translation along the vertical axis, and whose movement is managed by a toothed transmission belt (22D), moved by the pair of vertical translation pulleys (23D) and (23′D). The picking and distribution rack, in its vertical downward movement, determined by the length of the slotted rectangular plate (19D), meets the pear loading carriage (1) and stops; then, the operation of the pneumatic actuator (13D) determines the opening of the gripping mechanism (11D) and the pear is released, with the petiole facing downwards, in the jaws in the closed position (4), to form a pre cup of invitation and pre-alignment of the fruit for the housing cup (2), of the underlying loading carriage (1).

This device object of the present invention is, therefore, capable of automatically and efficiently guaranteeing the feeding of the pears into the housing cups (2) of the machine. The carriage (8D), to which each of the six thrust plates are fixed, is moved horizontally, in both directions, forward and backward, by the toothed belts (9D) and pulleys with bidirectional movement (10D) placed on the two sides of the intake rack with horizontal movement.

At the end of the stroke, each thrust plate (7D) deposits the pear with the peduncle facing downwards, into the specially shaped gripping mechanism (11D) of the gripping and dispensing rack.

Each gripping mechanism (11D) is shaped in two halves, connected by rotation pins (12D) and its opening and closing is controlled by a pneumatic actuator (13D).

Each half of the gripping mechanism (11D) consists of a differently shaped metal plate (14D) and (15D), which has a semi-support base and a vertical containment wall, shaped like a semicircle, at its bottom. The shaped plate (14D), in correspondence with the entry direction of the pear, is shaped so as not to interfere with the fruit, keeping it in a vertical position; in fact, its vertical wall is divided into two (16D), (17D) and the base has a slot (18D), within which the peduncle slides, when the inclined plate (7D) of the trolley (8D) pushes the fruit to lodge in the socket (11D).

The fruit gripping and distributing rack consists of a downward vertical transfer mechanism for distributing the pears, consisting of a rectangular plate with slots (19D) along its longitudinal centreline, and provided on the longitudinal sides with rails (20D), which allow it to slide on a pair of linear guides made up of L-section bars (21D), which guide the translation along the vertical axis, and whose movement is managed by a toothed transmission belt (22D), moved by the pair of vertical translation pulleys (23D) and (23′D).

The picking and distribution rack, in its vertical downward movement, determined by the length of the slotted rectangular plate (19D), meets the pear loading carriage (1) and stops; then, the operation of the pneumatic actuator (13D) determines the opening of the gripping mechanism (11D) and the pear is released, with the petiole facing downwards, in the jaws in the closed position (4), to form a pre cup of invitation and pre-alignment of the fruit for the housing cup (2, 2′), of the underlying loading carriage (1).

This device object of the present invention is, therefore, capable of automatically and efficiently guaranteeing the feeding of the pears into the housing cups (2,2′) of the machine. The figures show the racks provided with six adductors and six pear feeders in line, but they can also be less or greater than six.

The fruit loading trolley (1) includes the housing cups (2, 2′) in which the pears (3) are placed with the stem facing downwards.

Each housing cup (2,2′), is shaped, internally, in the shape of a funnel, and is surmounted by a pair of jaws (4), each formed by an opposite and curved shaped surface, provided with an appendage (4A), for the fixed connection, by means of screws, to two arms (5A,5′A) pivoted and hinged on the supports (6A). Below, the two arms (5A, 5′A) are further connected spaced apart, by means of a cylindrical spacer (7A).

The ends (8A) of the arms (5A) are suitably curved so that the bearings (9A, 9′A) fixed to them, are in contact with the thrust plate (10A). In particular, the two bearings (9A, 9′A) lie in line with the longitudinal axis of symmetry of the single-acting diaphragm cylinder (11A), when the jaws (4) are in the closed position. When the jaws (4) are in the open position, the two bearings (9A, 9′A) move apart but always remain within the limits and in contact with the surface of the thrust plate (10A).

The arm (5′A) ends with a curved end (12A) having a hole (13A) for hooking the terminal of a traction spring (14A).

Each pear housing cup (2,2′) is fixed to a central ring support (21A), and is supported and slides on a pair of linear guides made up of round section bars (15A), which guide the translation on the vertical axis of symmetry of the cup, the movement of which is managed by a pair of double-acting pneumatic cylinders (16A), assembled by a support bracket (17A), integral with the body of the pneumatic cylinders. Both the pair of linear guides which support the housing cup (2, 2′) and the stems (18A) of the pneumatic cylinders (16A), are fixed to the base (19A) of the loading trolley. For the housing cup (2′) the central ring support (21A) is provided on the upper surface with two pins or pins (22A) which rise vertically; the housing cup (2′), can vary in external and internal dimensions, is made with a circumferential gap (23A) where a retaining spring (24A) is placed, and the base of the housing cup (2′) is provided of two holes which form the seats in which said pins are positioned (22A) The spring is inserted in the circumferential gap (23A), on the cup, and then, by exerting pressure, the cup is positioned on the pins (22A); the spring first tends to widen slightly and then shrink around the pin seats, so that the cup remains blocked on the central ring support base (21A). In this way it is possible to change the housing cup (2′) quickly and easily when needed; for example, if the size or length of the pear has changed.

The loading carriage (1), is capable of guaranteeing the translation of the housing cup along its axis of longitudinal symmetry and in both directions, necessary for the alignment system of the machine where the device for housing and retaining the pear (2,2,′) it goes to install itself. The pair of cylinders positioned on the sides of the housing cup guarantees the large central space necessary for the evacuation of product waste during processing. The special shape of the jaws (4), when in the closed position, creates an invitation and guarantees a pre-alignment or self-centering of the fruit, in axis with the housing cup (2, 2′), and at the same time prevents it from coming out during motion, without creating unwanted crushing of the pear, in particular during the rotation operation, when the loading carriage (1) is overturned, and during translation, along the y axis, to meet the pad, i.e. the front part of the coring tool (5).

The loading carriage (1) is joined on a pin (10) and moved in the direction of the Y axis by the action of a system of cams (8) and levers (9, 9′), and a tie rod (6). By means of a pair of blocks (11) which act as sliding bearings on guide profiles (12), they induce, to the loading carriage (1), a rotation of 90° around the x axis, which causes that the axis vertical Z of the housing cup (2,2′) is parallel to the Y axis. Following the 90 degree rotation and the advancement of the loading carriage (1), the fruit encounters the punch of the enucleation tool (5) on which it is driven. By advancing the loading carriage (1), the pear continues its path of piercing on the enucleation tool (5) until it meets the pad (13). At this precise moment, the pad (13) acts as a ruler for positioning the fruit, reporting the measurement of the positioning of the pear, to a sensor which activates the retraction device of the housing cup (2).

The coring tool (5) consists of two rotating coaxial stems and is provided with lugs (14) for anchoring and traction of the fruit on the tool (5) itself, and two blades (15) for picking the pear. By rotating the stem of the coring tool (5), it allows its blades (15) to clean the fruit inside, simultaneously with the action of a special small cutter (not shown in the drawings) which, acting from the outside, can peel the pear.

The pad (13) also acts as an ejector of the fruit at the end of the processing, and is fixed to a cylindrical stem (16) which joins the square section bar (17), guided by the square bush (18), to which it is fixed the matching element (19), also called “touch”. This striker element (19) has an excursion movement between the side walls or sides of a C-profile bar (20), the longitudinal length of which develops parallel and in the direction of the X axis. The C-shaped bar (20) is moved by the set of cams (21) and levers (22) and is guided by a pair of circular section guides (23) which allow it to move linearly in the direction of the Y axis. The movement of the pear loading carriage (1) and the movement of the pear alignment/ejection pad (13) are opposed but synchronized and cyclical, ie they start and return to the same starting point, completing an entire cycle.

In an alternative embodiment of the present invention, the head limit switch (28) and the induction sensor (29), as well as the bar (7) with the graduated brackets (31), are replaced by an electronic position transducer (33) connected by cable (34) to a PLC which manages the parameters of the alignment system.

Each station or work station on the machine, although mounted on a single loading carriage (1), is structurally and operationally independent. Each alignment device is therefore autonomous, i.e. for each processing station there is a coring tool (5), a pad (13) and related mechanisms, an inductive limit switch sensor (29) or alternatively an electronic transducer (33), which controls the solenoid valve for the retraction movement of its housing cup (2, 2′) of which the station is a part.

The machine can be equipped with a loading carriage (1) having a number of stations or workstations in line, such that it is possible to carry out the required processing on a number of fruits at the same time, which in a preferred embodiment are six fruits, but can be even a smaller or larger number than six, respectively four stations or eight processing stations. The peeling device essentially consists of a fork rod with the cutter holder shaft, a toothed pulley to impart rotation, a shock absorber/damper element for the tilting movement, the spindle body with the cam guide and a tie rod for the roto-translational movement.

More specifically, the peeling device consists of a hollow tubular support rod (1P), surmounted and coupled with a hairpin (2P); inside the rod there is the rotation transmission spindle (3P) connected, at one end, to the circular cutter (4P) equipped with disc (5P) that adjusts the depth of action of the circular cutter (4P) on the skin of the pear, and a chip breaker tooth (6P).

The rotation transmission spindle (3P) at its top is provided with a ball joint (7P) which mates, engaging inside a transmission shaft (8P) with a bell-shaped end (9P), which in turn once, with the interposition of bearings, it engages in the flanged tubular (10P), provided on its lateral surface with a groove forming a cam (11P) for a vertical roto-translational movement. The end of the transmission shaft (8P) connects to a rotational sprocket (13P).

Externally to the flanged tubular (10P) and concentrically to it, there is an annular body (14P), bearing pins (15P), which engage in the vertical rototranslation cam (11P); above the annular body (14P), a ring plate (16P) is fixed, to which the tie rod (17P) is connected; a bracket (18P) is fixed below, intended to support the pneumatic fluid diaphragm shock absorber/damper (19P), whose thrust piston (20P), with the interposition of a spring (21P), acts on the arm (22P) connected to one of the flaps (23P), of the hairpin (2P).

The cutter holder shaft is not rigid but, resting elastically against the outside of the pear, it can tilt as necessary and raise or lower with a roto-translational movement, to follow the profile of the pear when moving from the calyx end to the peduncle.

The elastic inclination movement of the circular cutter (4P), is due to the presence of the ball joint (7P) at the top of the rotation transmission spindle (3P) and to the thrust piston (20P), which acts on the arm (22P), connected to the hairpin (2P); in this way the cutter-holder rod is able to follow the profile of a pear, averaging between a minimum and maximum value, which the pressure of the cutter on the pear's surface would assume.

The rotation of the cutter is imparted to the top, by means of the toothed pulley, which is connected to the flanged tubular (10P) which acts as a mandrel and on whose surface there is the cam (11P), necessary to impart through the annular body (14P), the height adjustment of the cutter inclination (4P)

### Method of Enucleation and Peeling of the Pears.

The attached figures, in addition to showing the components of the machine, illustrate, both in three-dimensional form and in plan form, their interconnected movements during the phases of distribution, housing, alignment and processing of the pears.

The gripping mechanism (11D), releases the pear with the petiole facing downwards, in the jaws (4) in the closed position, which create an invitation to favor the correct pre-positioning of the pear in the housing cup (2,2′), of the underlying loading carriage (1). The housing cup (2, 2′) is initially raised, the traction spring (14A) lengthened and the diaphragm cylinder (11A), with the thrust disc (10A), which presses on the bearings (9A, 9′ A), placed at the lower ends (8A), of the arms (5A), whose curved ends (8A) are aligned; when the spring (14A) from the extended position tends to return to the rest position, reducing the traction, the jaws (4) open to let the pear enter the housing cup (2,2′); in this case the thrust disc (10A) of the diaphragm cylinder (11A), located below the base (19A), does not put pressure on the bearings (9A, 9′A), located at the lower ends (8A) of the arms (5A), which tend to rotate on the fulcrum of the hinges (20A) opening the jaws (4), which close again and tighten around the fruit, through the action of the membrane cylinder (11A) which, pushed by a control, with the thrust disk (10A), puts pressure on the bearings (9A, 9′A), located at the lower ends (8A), of the arms (5A) which tend to rotate on the fulcrum of the hinges (20A) and bring the spring back under tension.

The axial retraction of the housing cup (2, 2′) away from the jaws, (as well as its axial advance towards the jaws), is determined by the action of the pair of double-acting pneumatic cylinders (16A).

The cyclical fruit alignment/ejection movement, in the synthetic representation given by the said figures, begins when the loading carriage (1), housing a pear, begins to move and rotates 90 degrees to position the pear and center it in front of the punch of the enucleation tool (5); the pad (13) from a position of maximum travel, moves along the y axis, going backwards, and positions itself at a precise point relative to the tool (5), immediately after the blades (15), distant from the point beginning of its minimum excursion.

It is understood that the maximum excursion of the pad (13) along the coring tool (5) coincides with the free end of the latter, while the minimum excursion is facing the end connecting to the rotation mechanism (30) of the coring tool (5) on the machine frame. The loading carriage (1) continues to move in a linear manner by sticking the pear on the nucleation tool (5) until it touches the surface of the pad (13); at this precise moment, the phase of alignment of the pears on the coring tool (5) begins.

The loading carriage (1) advances further and the pressure exerted by the pear, in the direction of translation Y, against the pad (13), causes the striker element (19), attached to the end of the square section bar (17), can slide in the direction of the Y axis, within the width of the C-profile bar (20) between the side rails.

The striker element is found to touch the opposite lateral sides of the C-profile bar (20), when the pad (13) is in the maximum excursion position or in the alignment start position close to the enucleation blades. Integral with the square bar (17) is the fork bracket (24) which in turn pushes the rod (25) on which there are two rulers (26, 27) which regulate its excursion and repositioning in the initial position of the head limit switch (28).

When the head limit switch (28), during its translation, reaches the induction sensor (29), this will command a solenoid valve which will make the housing cup (2) retract in the opposite direction of the movement of the loading carriage (1)

Each induction sensor is positioned on a bar (7) whose position, relative to the Y axis, is manually adjusted on the brackets (31), equipped with a graduated scale (32). This allows to correctly determine the position of the pear on the coring tool, when it is necessary to work with pears having quite different calibration.

The alignment phase ends when the plug (13), as the pear moves forward on the loading carriage (1), reaches the correct position for coring the pear.

After which the pad (13) moves further back to the minimum excursion position and at the same time the loading carriage (1) returns to the starting point, the housing cups (2,2′) are raised again and the peeling and coring process begins. For this purpose, the peeling device is arranged on the machine in a position that agrees with the alignment position of the pears on the peeling and coring tool.

To obtain a good peeling, the cutter must follow the real profile of each single pear to be peeled, and its pressure on the pear must not assume values such as to partially penetrate the pear, when this has a certain degree of ripeness or in any case has not a sufficient and/or uniform consistency.

The technical arrangements which have been provided for in the peeling device meet these requirements, in fact the continuity of adhesion to the surface of the pear, during the peeling process, is improved; it can be ensured that the cutter always comes into contact with pears, even of different shapes and even with irregular skin; in removing the thickness of the thin skin, the loss of edible material is reduced, and the device is suitable for large-scale rapid peeling operations of pears.

After fruit processing, the fruit alignment/ejection pad (13) advances, pushing the processed fruit, and reaches its maximum excursion on the nucleation tool (5), expel the pear; at the same time the head limit switch (28) is repositioned back again, retracting the fork bracket (24).

The loading trolley (1) which has returned to the starting point, is ready to receive a new pear, and the pad (13), from the maximum excursion position, goes back and remains stationary at the starting detection point which is determined by the position assumed by the return excursion of the striker element (19), between the lateral sides of the C-shaped bar (20), until touching the opposite side.

1. Continuous cycle machine, having a single or more processing stations, aligned and integrated on a carriage of pears loading, with which it is possible to carry out the enucleation and peeling of the pears, and in which each single processing station, served by a system of feeding, is provided by the assembly forming a housing cup, of a mechanism that carries out the alignment starting from the calycine end of the pear to be worked, of a tool for enucleating the endocarp of the pear, with its rotating blades, with an alignment and expulsion pad, fixed to a cylindrical rod, of a rapid peeling tool and an activation sensor of a retraction control solenoid valve of each housing cup, characterized in that:
the pear feeding system is formed by a first rack for feeding the pears with horizontal movement and by a rack for gripping and distributing the pears with vertical movement; and in which the gripping and distributing rack consists of a gripping mechanism (11D), shaped in two halves connected by rotation pins (12D), the opening and closing of which is controlled by a pneumatic actuator (13D); the gripping mechanism (11D) is connected to a slotted rectangular plate (19D), provided on the longitudinal sides with rails (20D), and a pair of linear guides made up of L-section bars (21D); a toothed transmission belt (22D), moved by the pair of vertical translation pulleys (23D) and (23′D), manages the translation of the slotted rectangular plate (19D) along the vertical axis;
the pear housing cup (2, 2′), internally funnel-shaped (2A), is supported and sliding on a pair of linear guides, made up of round-section bars (15A), and provided with a pair of pneumatic cylinders at double effect (16A), wherein the stems (18A) are fixed to the base (19A) of the pear loading carriage (1) and assembled by a support bracket (17A); the housing cup (2,2′) is provided with jaws (4), each formed by an opposed surface, curved shaped and provided with an appendix (4A), for the fixed connection, by means of screws, to two arms (5A, 5′A) pivoted and hinged on the supports (6A); it is further provided with radial ball bearings (9A, 9′A) fixed to the ends (8A) of the arms (5A), placed in contact with the surface of the thrust disc (10A), of the diaphragm cylinder (11A); further provided with a traction spring (14A), hooked to the curved end (12A), of the arms (5′A), having a hole (13A);
the cylindrical rod (16) of the alignment and expulsion pad (13) joins a square section bar (17), guided by a square bush (18), to which a striker element (19) is fixed, the whose excursion movement is included between the lateral sides of a C-profile bar (20) which develops, in longitudinal length, parallel and in the direction of the x axis, and in which the C-profile bar (20), is connected to the set of cams (21) and levers (22) and translates linearly guided by a pair of guides with a circular section (23), in the direction of the orthogonal transversal axis Y; and in which the head limit switch (28) is placed at the free end of a rod (25); on which there are two rulers (26, 27), which can be adjusted on the same rod (25); and in which the fork bracket (24) is integral with the square section bar (17); and in which the position of the starting point for detecting the pad (13) is between the maximum or minimum excursion position of the striker element (19) on the C-shaped bar (20);
the rapid peeling tool consists: of a fork rod with the rotation transmission spindle (3P) connected to the circular cutter (4P), and a transmission shaft (8P) is connected to a toothed pulley (13P) to imprint the rotation; of a spindle with a cam guide (11P) and an annular body (14P), connected to a tie rod (17P) for the rototranslational movement, and of a shock absorber/damper device (19P), with the push piston (20P), for the inclination of the fork rod;
the activation sensor is an induction sensor (29) positioned on a bar (7), and close to the brackets (31), equipped with a graduated scale (32) for manual adjustment of the excursion, relative to the Y axis, of the bar (7); or the activation sensor is an electronic transducer of position, connected by cable to a PLC.

2. Continuous cycle machine, having a single or more processing stations, aligned and integrated on a loading carriage, as in claim 1) characterized in that each half of the gripping mechanism (11D) consists of a differently shaped metal plate (14D) and (15D), which provides, at the bottom, a semi-support base and a vertical containment wall in the shape of a semicircle; the shaped plate (14D), has its vertical wall divided into two (16D), (17D), and the base has a slot (18D), within which the peduncle of the pear slides, when the inclined plate (7D), of the carriage (8D), pushes the pear with the peduncle downwards, to lodge in the gripping mechanism (11D)

3. Continuous cycle machine, having a single or more processing stations, aligned and integrated on a loading carriage, as in claim 1), characterized in that the horizontally moving feed rack is made up of rotary selectors (3D), V-shaped channels (4D) with facing flared sides converging towards the open bottom and each having a pair of toothed belts (5D) moved by unidirectional drive pulleys (6D, 6′D), a trolley (8D), moved by bidirectional drive pulleys (10D, 10′D) and toothed belt (9D), to which thrust plates (7D) are fixed.

4. Continuous cycle machine with a single or more aligned and integrated processing stations, as in claim 1), characterized in that the housing cup (2.2′) has the two arms (5A, 5′A) connected spaced apart, for means of a cylindrical spacer (7A); the two bearings (9A, 9′A) lie in line with the longitudinal axis of symmetry of the single-acting diaphragm cylinder (11A), when the jaws (4) are in the closed position.

5. Continuous cycle machine with a single or more aligned and integrated processing stations, as in claim 1) characterized in that the housing cup (2′) is interchangeable, is made with a circumferential gap (23A) where it is placed a retaining spring (24A); and in which the base of the housing cup (2′) is provided with two holes which form the seats within which the pins (22A) are placed.

6. Continuous cycle machine with a single or more aligned and integrated processing stations, as in claim 1) characterized in that the fork rod of the rapid peeling tool is made up of a hollow tubular support rod (1P), surmounted and coupled with a fork (2P), and inside there is the rotation transmission spindle (3P), connected at one end to the circular cutter (4P), equipped with a disc (5P) for adjusting the depth of action of the circular cutter (4P) on the pear skin, and a chip breaker tooth (6P).

7. Continuous cycle machine with a single or more aligned and integrated processing stations, as per claim 1) characterized in that the rotation transmission spindle (3P) of the rapid peeling tool, at its top is provided with a ball joint (7P), which couples, engaging inside the bell-shaped end (9P), of the transmission shaft (8P), which in turn, with the interposition of bearings, engages in the mandrel (10P) which is a flanged tubular, provided on its lateral cylindrical surface with a pair of groove opposing forming a helical cam (11P); and in which the other end of the transmission shaft (8P) is connected to a rotation toothed pulley (13P).

8. Continuous cycle machine with a single or more aligned and integrated processing stations, as per claim 1), characterized in that externally to the flanged tubular element of the mandrel (10P), and concentrically to it, there is an annular body (14P) carries the seats (15P) for pins which engage in the vertical rototranslation helical cam (11P); and in which above the annular body (14P), a ring plate (16P) is fixed to which the tie rod (17P) is connected; a bracket (18P) is fixed below, intended to support the shock absorber/damper device (19P) with pneumatic membrane fluid, whose thrust piston (20P), with the interposition of a spring (21P), acts on the arm (22P) connected to one of the ends (23P) of the fork (2P).

9. Continuous cycle machine with a single or more aligned and integrated processing stations, as in claim 1), characterized in that the elastic inclination movement of the circular cutter (4P), is due to the presence of the ball joint (7P) at the top of the rotation transmission shaft (3P), and at the push piston (20P), which acts on the arm (22P), connected to the fork (2P); the rotation of the cutter is imparted to the top of the device, by means of the toothed pulley (13P), which is connected to the flanged tubular body of the mandrel (10P), and on whose surface there is the cam (11P), necessary to impart, through the annular body (14P), the height adjustment of the cutter (4P).

10. Continuous cycle machine with a single or more processing stations aligned and integrated on a loading carriage, in which it is possible to core and peel the pears, according to claim 1) and following, in which the orthogonal axes X, Y and Z are relative to the indication of a direction in space, of the movement of each device; also the words: low, high, minimum, maximum, forward, backward are relative to an indication of direction, respectively: the words low and high along the Z axis; the words minimum, maximum, forward, backward, along the Y axis.

11. Pear coring and peeling method for a continuous cycle machine with a single or more aligned and integrated processing stations, characterized by the fact that a vertical gripping and distributing rack, in its downward movement, determined by the length of a slotted rectangular plate (19D), measured along its longitudinal centreline, meets the pear on loading carriage (1) and stops; the activation of the pneumatic actuator (13D) determines the opening of the gripping mechanism (11D) and the pear is released, with the petiole facing downwards, in the jaws (4), in the closed position, of the housing cup (2, 2′) of the underlying loading carriage (1); the jaws (4) form a guide for the axial pre-alignment or self-centering of the pears; the alignment of the pear (3), on a coring tool (5), takes place through a cyclical movement that begins with a first phase in which:
the loading carriage (1) housed with the pears, rotated 90 degrees, moves in a linear manner, sticking each pear on the coring tool (5) until it touches the surface of a pad (13), which from a primiera position of maximum travel, coinciding with the free end of the coring tool (5), moving along the y axis, when going back, it is positioned in a precise point on the coring tool (5), immediately after the blades (15);
a second phase in which: the loading carriage (1) continues to advance in the direction of translation Y, and the pressure exerted by the pear, against the pad (13), causes the striker element (19), attached to the end of the square section bar (17), can slide in the direction of the Y axis, within the width, between the side edge of a C-profile bar (20); integral with the square section bar (17), is a fork bracket (24), which in turn pushes the rod (25), on which there are the rulers (26, 27), suitably pre-adjusted, so as to determining the range of the translation of a head limit switch (28) in reaching the induction sensor (29), which controls a solenoid valve for the retraction of the housing cup (2,2′), in the opposite direction of the movement of the loading carriage (1);
the alignment cycle ends with a third phase in which the peeling and enucleation process of the pear endocarp begins on the enucleation tool (5), when the pad (13) returns to its minimum excursion position, facing the point of connection of the coring tool (5) to the rotation mechanism (30), and at the same time the loading carriage (1) returns to the position for receiving a new pear.

12. Pear coring and peeling method for a continuous cycle machine with a single or more aligned and integrated processing stations according to claim 11) characterized in that the pear is expelled when the C-shaped bar (20), moves forward along the Y axis, at the same time the fork bracket (24) retracts, and the head limit switch (28) moves away from the sensor (29), and consequently the pad (13) advances up to its maximum excursion, expelling the pear.

13. Pear coring and peeling method for a continuous cycle machine with a single or more aligned and integrated processing stations, as in claim 11) and following, characterized in that when the rod (25) advances towards an electronic transducer position (33), this emits the signal for a PLC to move the housing cup (2,2′) back; in this way the alignment of the pear has been determined, and the peeling and enucleation of the pear endocarp begins.

14. Pear coring and peeling method for a continuous cycle machine with a single or more aligned and integrated processing stations, as in claim 11) and following ones in which the orthogonal axes X, Y and Z are relativized to the indication of a direction in space, of the movement of each device; also the words: low, high, minimum, maximum, forward, backward are relative to an indication of direction, respectively: the words low and high along the Z axis; the words minimum, maximum, forward, backward, along the Y axis.
